(19) United States
(12) Patent Application Publication
(10) Pub. No.: US 2017/0164777 A1
(43) Pub. Date: Jun. 15, 2017

(54) INDUCTION COOKTOP

(71) Applicant: Spectrum Brands, Inc., Middleton, WI (US)

(72) Inventors: David William Everett, JR., Verona, WI (US); Karl Warner Marschke, Madison, WI (US); Vignesh Manikandan Pirathaban, Madison, WI (US)

(21) Appl. No.: 15/374,305

(22) Filed: Dec. 9, 2016

Related U.S. Application Data
(60) Provisional application No. 62/265,584, filed on Dec. 10, 2015.

(51) Int. Cl. A47J 27/00; H05B 6/12

(52) U.S. Cl. CPC A47J 27/002; A47J 27/004; H05B 6/1209

(57) ABSTRACT

An induction cooktop includes a housing defining a cavity, an inner induction coil positioned within the cavity and having a first shape, and an outer induction coil circumscribing the inner induction coil within the cavity and having a second shape different from the first shape of the inner induction coil.

### CROSS-REFERENCE TO RELATED APPLICATION

This application claims the benefit under 35 U.S.C. §119(e) of U.S. Provisional Patent Application No. 62/265,584, filed Dec. 10, 2015 and titled “Induction Cooktop,” which is incorporated herein by reference in its entirety.

### BACKGROUND

The present invention relates generally to induction heating appliances, and more particularly to an induction cooktop for heating cooking vessels.

Some known cooking appliances such as cooktops and portable grills use induction heating to heat a cooking vessel, or to heat food directly, where electric currents are applied to heating coils to generate magnetic flux through the cooking vessel or food. Such appliances typically include one or more circular coils positioned below a rectangular cooktop cover plate.

One drawback associated with at least some known cooking appliances is that heat is unevenly distributed across the cover plate because the transfer of heat is limited to the area covered by the coil. Cooktops that employ multiple coils within the cover plate may also suffer from uneven heat distribution because the coils are typically spaced apart to enable the use of different cooking containers. Additionally, multiple coil cooktops include separate power controls for each coil, which increases the cost and number of components.

It would also be desirable to be able to place a grill plate over the induction cooktop cover plate to convert the appliance to a grill for cooking food placed in direct contact with the grill plate. However, different types of grill plates, e.g., a griddle, a ribbed plate, etc. are typically constructed different from each other. As a result, each has its own operating limiting as to how hot the grill plate can beheated.

There is a need, therefore, for an induction type cooktop that more uniformly distributes heat over the cooktop cover plate. There is also a need for such an induction type cooktop which is capable of receiving and recognizing different types of grill plates over the cooktop cover plate.

### SUMMARY

In one embodiment, an induction cooktop generally comprises a housing defining a cavity, an inner induction coil positioned within the cavity and having a first shape, and an outer induction coil circumscribing the inner induction coil within the cavity and having a second shape different from the first shape of the inner induction coil.

In another embodiment, a cooktop system generally comprises a housing and a heating assembly disposed in the housing. A first grill plate is selectively releasably attachable to the housing over the heating assembly to define a cooking surface, with the grill plate being of a first type of grill plate. A second grill plate is selectively releasably attachable to the housing over the heating assembly in place of the first grill plate, with the second grill plate being of a second type of grill plate having at least one characteristic that distinguishes the second type of grill plate from the first type of grill plate. A grill plate identification system is disposed on the housing, the first grill plate and the second grill plate to determine which of the first grill plate type and the second grill plate type is attached to the housing. A control card is configured to apply predetermined operating limits to the heating assembly based on the grill plate type determination made by the grill plate identification system.

### BRIEF DESCRIPTION

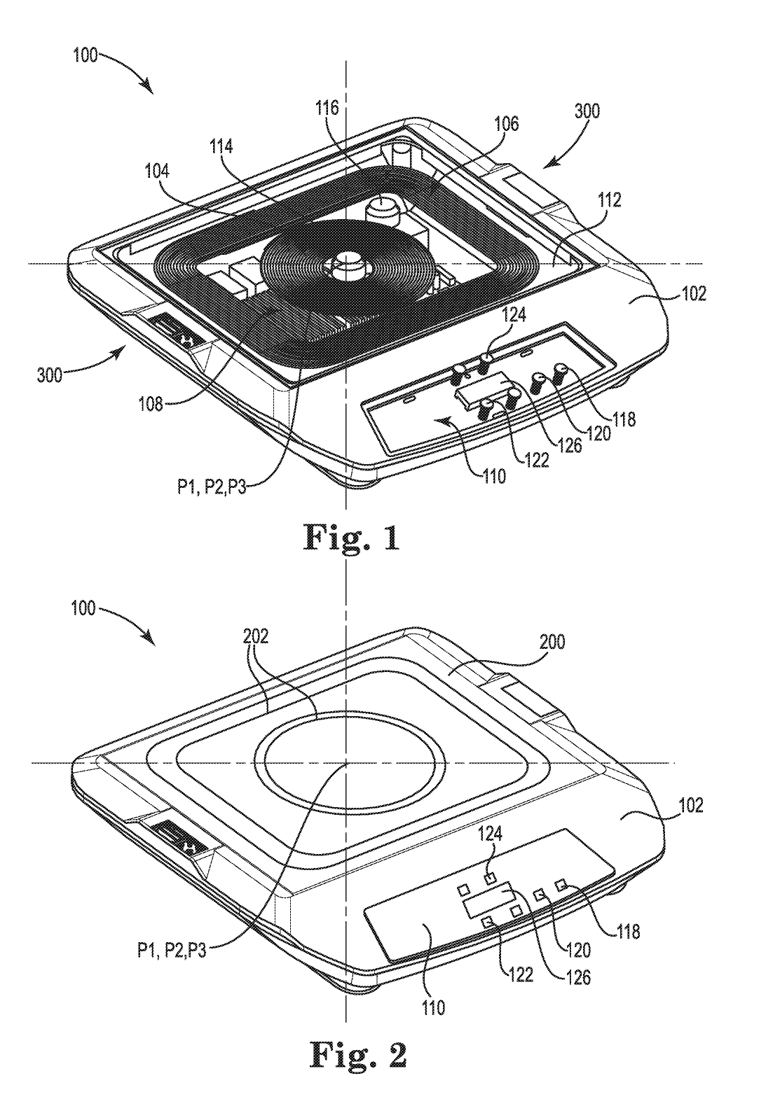

FIG. 1 is a perspective view of an exemplary induction cooktop in accordance with one embodiment of the present disclosure;

FIG. 2 is a front view of the cooking appliance shown in FIG. 1;

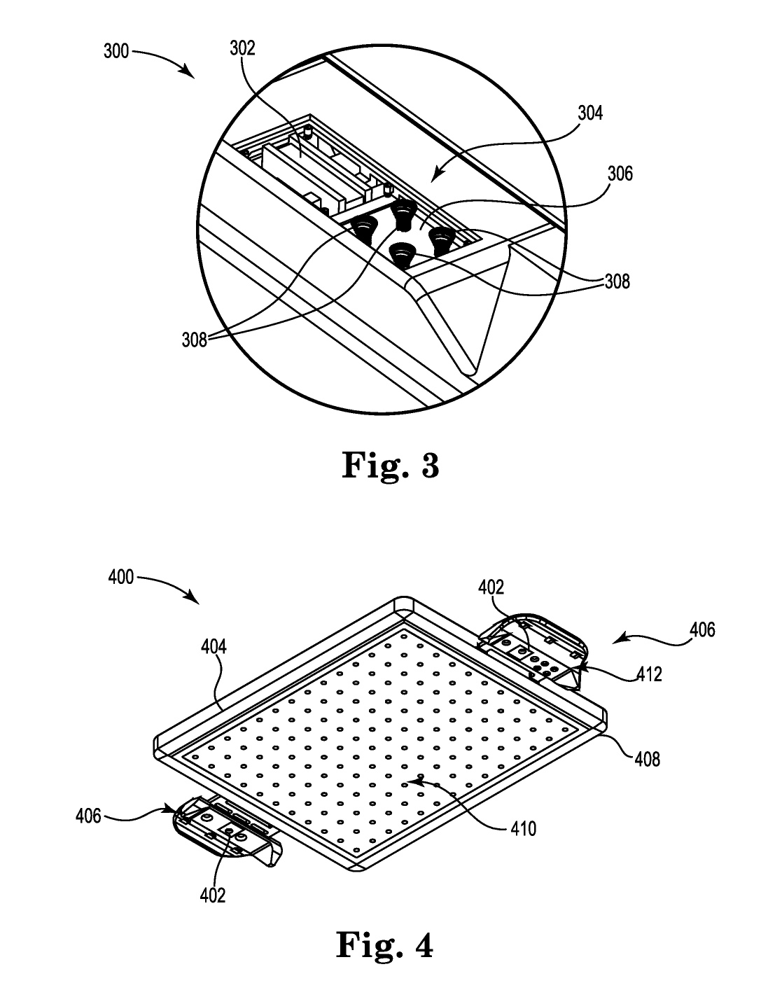

FIG. 3 is an enlarged perspective view of an alignment member included within the induction cooktop shown in FIGS. 1 and 2;

FIG. 4 is a bottom perspective view of a grill plate that may be coupled to the induction cooktop shown in FIGS. 1 and 2;

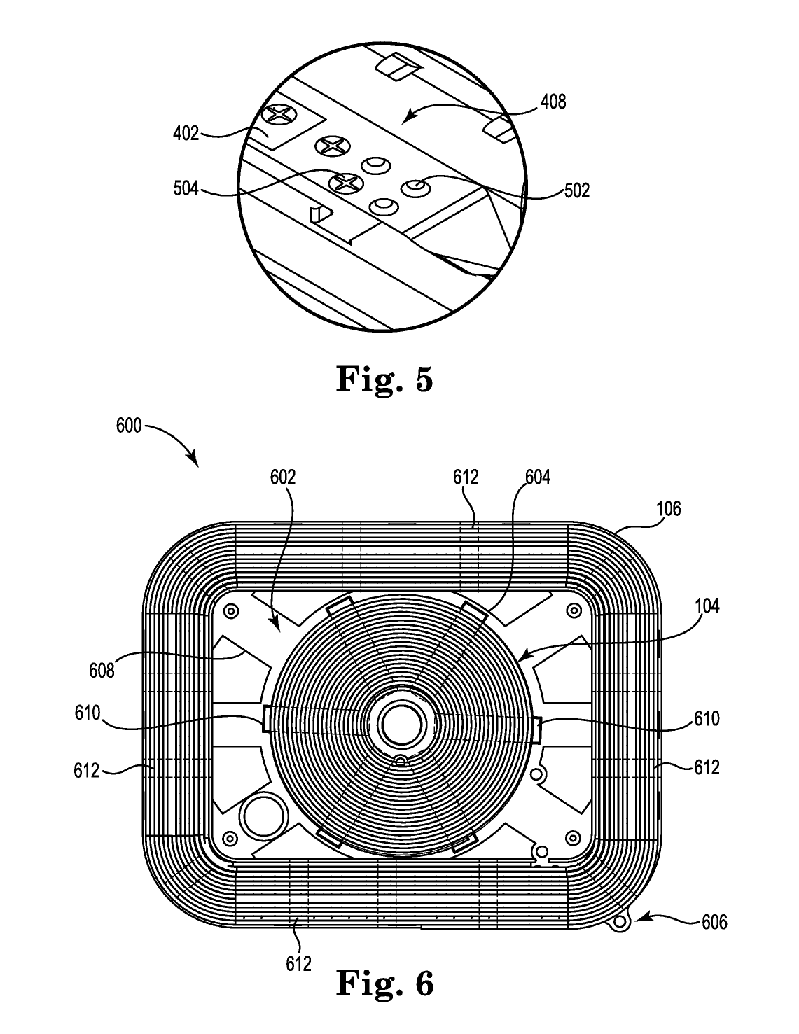

FIG. 5 is an enlarged perspective view of a grill plate identification device that may be used with the grill plate shown in FIG. 4; and

FIG. 6 is a top plan view of an exemplary induction coil assembly that may be used with the induction cooktop shown in FIG. 1.

Corresponding reference characters indicate corresponding parts throughout the several views of the drawings.

### DETAILED DESCRIPTION

FIG. 1 is a perspective view of an exemplary induction cooktop 100. FIG. 2 is a perspective view of the induction cooktop 100 shown in FIG. 1, including a cover plate 200. The induction cooktop 100 includes a housing 102, an inner coil 104, an outer coil 106, a power board 108, a control card 110, and a cover plate 200. In the illustrated embodiment, the inner coil 104 and the outer coil 106 are disposed atop the power board 108 within a cavity 112 defined in the housing 102.

The cover plate 200 is coupled to an upper portion of the housing 102 to enclose the inner coil 104, the outer coil 106, and the power board 108 within the housing 102. The cover plate 200 is generally rectangular in shape, consistent with a shape of the cavity 112 of the housing 102, and is centered about a first center point P1. The cover plate 200 is made of a heat-resistant tempered glass that enables energy to be transferred from the inner coil 104 and/or the outer coil 106 to a cooking container (e.g., a pot, kettle, pan, etc.) seated on a top surface of the cover plate 200. Energy generated by applying power to the inner coil 104 and the outer coil 106 is transferred to the cooking container via the cover plate 200. In some embodiments, the cover plate 200 may include coil identification markings 202 that illustrate positions of the inner coil 104 and the outer coil 106 underneath the cover plate 200. The coil identification markings 202 are configured to assist a user in placing a cooking container directly above one of the induction coils 104, 106 such that an increased amount of energy may be transferred to the cooking container, resulting in more efficient operation of the induction cooktop 100.

In the illustrated embodiment, the inner coil 104 is positioned within the cavity 112. The inner coil 104 is a circular-wound coil having a center point P2. The inner coil 104 is positioned within the housing 102 at a center point P2, which substantially coincides with the center point P1 of the cover plate 200. In the illustrated embodiment, the inner coil 104 is either a Litz wire or a multi-conductor cable. The inner coil 104 may be formed by winding the wire several times in a circular shape. For example, in the illustrated embodiment, the inner coil 104 includes 21 turns and has an outer diameter of approximately 6 inches. However, the inner coil 104 may be wound with any number of turns and may have any diameter that enables the inner coil 104 to function as described herein.

When a cooking container is seated on the cover plate 200, energy is most efficiently induced into the cooking container directly above the inner coil 104. Accordingly, induction cooktops that include one or more circular-wound induction coils will have cold spots on the cover plate 200 at positions where there are spaces between the circular coils. A cold spot is an area on the cooktop that does not interface with an induction coil and accordingly, requires a longer time period to heat up and has significantly lower operating temperature than areas of the cooktop that do interface with the induction coil.

The outer coil 106 circumscribes the inner coil 104 within the cavity 112. More specifically, the outer coil 106 is positioned radially outward from the inner coil 104. The outer coil 106 is preferably electrically coupled to the inner coil 104. In at least one embodiment, the outer coil 106 is electrically coupled in series to the inner coil 104. The outer coil 106 is positioned within the housing 102 at a center point P3, which substantially coincides with both of the center points P1 and P2. In the illustrated embodiment, the outer coil 106 is either a Litz wire or a multi-conductor cable. The outer coil 106 is rectangular in shape such that it substantially matches the rectangular shape of the cover plate 200. The outer coil 106 may be formed by winding the wire several times in a rectangular shape such that the outer coil 106 substantially aligns with the peripheral edges along a perimeter of the cover plate 200. For example, in the exemplary embodiment, the outer coil 106 includes 15 turns and has outer dimensions of approximately 12 inches long and approximately 9.5 inches wide. The combination of the outer coil 106 and the inner coil 104 increases an area of the cover plate 200 that interfaces with a portion of the induction coil, which reduces the existence of cold spots and provides a more consistent heat distribution across the entire area of the cover plate 200. The portions of the cover plate 200 that do not directly interface with one of the induction coils 104, 106 occur in spaces between the inner coil 104 and the outer coil 106, so they will heat up in a shorter time period as energy is induced from both sides of the empty space.

The power board 108 is configured to condition input power received from a power source and supply alternating current (AC) power having a predetermined frequency to the inner coil 104 and/or the outer coil 106. To condition the input power, the power board 108 may include a power converter, such as a rectifier, that converts AC input power to direct current (DC) power. The DC power may be further smoothed by a filter capacitor before it is inverted to AC output power having the predetermined frequency by an inverter based on received control signals. The AC output power is applied to the inner coil 104 and/or the outer coil 106 at levels dependent on a mode of operation and/or specified mode parameters such as time or temperature.

The power board 108 includes a first resonant capacitor 114 coupled to an end of the inner coil 104 and to a negative bus power line of the power board 108. A second resonant capacitor 116 is coupled to an end of the outer coil 106 and to the negative bus power line of the power board 108. The first and second resonant capacitors 114 and 116 have the same operating values. In the illustrated embodiment, the inner coil 104 and the outer coil 106 are able to be controlled using the same resonant capacitors because the inner and outer coils 104 and 106 have approximately the same inductance values. When the inner and outer coils 104 and 106 are coupled to the first and second resonant capacitors 114 and 116 respectively, they have substantially identical resonant frequencies. This configuration enables the full power of the power board 108 to be applied to either the inner coil 104 or the outer coil 106 when there is high energy demand. As the high energy demand subsides, power may then be distributed between the inner and outer coils 104 and 106 to induce energy in each that maintains a desired temperature setting.

The control card 110 is configured to provide the control signals to the power board 108 to control the operation of the induction cooktop 100, and more specifically to the inner coil 104 and the outer coil 106. In the illustrated embodiment, the control card 110 is provided in the front end of the housing 102 and is communicatively coupled to the power board 108 to control AC power provided to the inner coil 104 and/or the outer coil 106 based on control inputs received from a user.

In the illustrated embodiment, the control card 110 includes a power button 118, a mode parameter selection button 120, and target mode parameter adjustment buttons 122 and 124. The mode parameter selection button 120 and the target mode parameter adjustment buttons 122 and 124 are examples of input devices for selecting a mode parameter and setting a target parameter. Alternative input devices usable with the induction cooktop 100 may include, for example, slide switches, buttons, toggle switches, knobs, touch screens, user interfaces, and/or any other type of suitable input device. Further, in some embodiments, a user may select a mode and/or set a cooking time using a computing device (e.g., a tablet, a desktop computer, a laptop computer, a mobile phone, etc.) as the input device, where the computing devices communicates with the induction cooktop 100 over a wired and/or wireless network, such as the Internet. For example, the user may use a software application on a computing device that enables the user to input a selected mode and/or set a cooking time, where the input information is communicated from the computing device to the induction cooktop 100.

In this embodiment, by depressing the mode parameter selection button 120, a user may select different mode parameters of operation for the induction cooktop 100 based on the user's preference of cooking method for the type of food product to be cooked. Specifically, the control card 110 controls power supplied to the inner coil 104 and/or the outer coil 106 based on the selected mode parameter. The control card 110 also includes a display device 126 that indicates displays information to the user relating to the mode of operation and the operating mode parameter, such as time and/or temperature.

At least one input device (e.g., the mode parameter selection button 120) enables a user to select an operating mode parameter for the induction cooktop 100. Each of the selectable modes may correspond to, for example, cooking a different type of food product. Although examples of specific modes are described herein, other modes not specifically described are within the spirit and scope of this disclosure.

FIG. 3 is an enlarged perspective view of an alignment member 300 included within the induction cooktop 100. FIG. 4 is a bottom perspective view of a grill plate 400 that may be coupled to the induction cooktop 100. FIG. 5 is an enlarged perspective view of a grill plate identifier 412 that may be used with the grill plate 400 (shown in FIG. 4). Referring to FIGS. 1-5, the housing 102 of induction cooktop 100 includes a pair of alignment members 300 for receiving the grill plate 400, as set forth in more detail below. Each alignment member 300 includes a first magnet device 302 and a grill plate identification device 304. The first magnet device 302 is configured to magnetically couple to a second magnet device 402 (FIGS. 4 and 5) associated with the grill plate 400 to secure the grill plate to the induction cooktop 100.

The grill plate identification device 304 is configured to communicate with a grill plate 400 coupled to the cooktop 100 to determine identification information representing a type of the grill plate. The grill plate identification device 304 includes a capacitive touch input card 306 and a plurality of capacitive touch input sensors 308 extending vertically from the capacitive touch input card 306. A small amount of power is provided to the sensors 308, and each sensor 308 is configured to detect an electrically capacitive circuit formed when the grill plate 400 is coupled to induction cooktop 100. When a capacitive circuit is detected by one or more of the capacitive touch input sensors 308, the capacitive touch input card 306 communicates a signal to the control card 110 identifying which sensors 308 made a detection.

The grill plate 400 includes a plate section 404 and a pair of handles 406 coupled to opposing edges of the grill plate 400. The plate section 404 has a rectangular shape and has an area that is substantially similar to the cover plate 200, which enables easy connection of the grill plate 400 on the induction cooktop 100 without changing a size of the cooking surface. The grill plate 400 includes a lip 408 configured to be seated on the housing 102 surrounding the cover plate 200. The lip 408 defines a recess 410 on the bottom of the grill plate 400 that is seated against the cover plate 200. The grill plate 400 interfaces with the cover plate 200 such that heat generated by the inner and outer coils 104 and 106 is transferred to the grill plate 400 for heating and/or cooking an object.

The handles 406 are configured to interface with the alignment members 300 of the housing 102 to facilitate detachable connection (e.g., magnetic connection) of the grill plate 400 to the housing 102 in a manner that properly aligns the grill plate 400. As such, the grill plate 400 may be removed from the housing 102 for cleaning or replacement.

Each handle 406 of the grill plate 400 includes the second magnet device 402 and a grill plate identifier 412. Second magnet device 402 is configured to magnetically couple to the first magnet device 302 of the alignment member 300 to couple the grill plate 400 to the induction cooktop 100.

The grill plate identifier 412 includes a plurality of cavities 502, each configured to receive a conductive member 504 therein. By varying configurations of which cavities 502 include conductive members 504, the type of the grill plate 400 may be defined. The conductive member 504 may include a screw, a plug, or any other conductive member that enables the grill plate identifier 412 to function as described herein.

During operation, when the grill plate 400 is coupled to the induction cooktop 100, the first magnet device 302 and the second magnet device 402 form a magnetic connection to secure the grill plate 400 to the housing 102. Additionally, the grill plate identifier 412 is caused to interface with the grill plate identification device 304. More specifically, the conductive members 504 positioned in the handle 406 of the grill plate 400 contact the capacitive touch input sensors 308. When a small amount of power is provided by the power board 108 to the sensors 308, an electrical circuit is formed between the sensor 308 and an associated conductive member 504.

When a sensor 308 detects that such a circuit is formed, the capacitive touch input card 306 communicates a signal to the control card 110 identifying which sensors 308 made the detection. Based at least partially on the signal received from the grill plate identification device 304, the control card 110 is configured to apply predetermined operating limits to the cooktop 100 based on the identification information determined by the grill plate identification device 304. More specifically, based on the received signal and a lookup table stored in a memory device (not shown) associated with the control card 110, the control card 110 is configured to identify the type of the grill plate 400 coupled to the induction cooktop 100. The control card 110 identifies which sensors 308 detected a circuit and correlates the configuration of identified sensors 308 to a predefined grill plate configuration. Grill plate types may include, but are not limited to including, a waffle plate, a bake dish, a muffin pan, a slider plate, a griddle plate, and an omelet plate.

Various different grill plates may be used interchangeably with induction cooktop 100. Different grill plates have a variety of base metals and coatings, each of which have various attributes relating to the cooking process such as thermal heat distribution, energy transfer, and non-stick characteristics. Such attributes at least partially define operating limits for each grill plate, such as a maximum operating temperature. The operating limits are stored in the memory device of the control card 110. Upon identifying the grill plate type, the control card 110 retrieves the predefined operating limits for the particular grill plate 400 from the memory device and applies them during operation of the induction cooktop 100.

The automatic grill plate recognition feature improves the overall safety of the user when operating the induction cooktop 100. Additionally, the automatic grill plate recognition feature prevents operating the induction cooktop 100 at temperatures that exceed the temperature ratings for a specific grill plate 400 attached to the induction cooktop 100, which assists in preventing damage to components of the induction cooktop 100 and/or the grill plate 400.

FIG. 6 is a top plan view of an exemplary induction coil assembly 600 that may be used with the induction cooktop 100 (shown in FIG. 1). In the illustrated embodiment, the induction coil assembly 600 includes the inner coil 104, the outer coil 106, and a frame 602 configured to maintain the inner coil 104 and the outer coil 106 at predetermined positions. The frame is configured to be mounted within the cavity 112 of the housing 102. The frame 602 may be manufactured from plastic or any other suitable material.

The frame 602 includes an inner coil section 604, and outer coil section 606, and a plurality of support members 608 extending between the inner coil section 604 and the outer coil section 606. The inner coil section 604 includes a circular tray configured to receive the inner coil 104 and maintain it in a fixed position. Within the inner coil section 604, a plurality of first ferrite bars 610 are coupled to a bottom side of the inner coil 104. More specifically, the first ferrite bars 610 are disposed between the frame 602 and the inner coil 104. The first ferrite bars 610 extend in a radial direction relative to the center of the inner coil 104 and terminate slightly beyond an outer periphery of the inner coil 104. The first ferrite bars 610 are configured to increase a magnetic field generated in the inner coil 104.

Similarly, the outer coil section 606 includes a rectangular tray configured to receive the outer coil 106 and maintain it in a fixed position. Within the outer coil section 606, a plurality of second ferrite bars 612 are coupled to a bottom side of the outer coil 106. More specifically, the second ferrite bars 612 are disposed between the frame 602 and the outer coil 106. The second ferrite bars 612 extend a distance substantially equal to a width of the outer coil 106. The second ferrite bars 612 are configured to increase a magnetic field generated in the outer coil 106.

The cooktops described herein provide an induction coil assembly that improves heat distribution throughout a cover plate of a cooktop. Depending on a surface area of an object to be heated, the cooktop described herein may supply power only to an inner coil, an outer coil, and/or both the inner and outer coils. As compared to at least some known induction cooktops, the cooktops described herein provide a move even heat distribution for cooking an object, heat the cover plate more rapidly and uniformly, and improve efficiency by heating only the portions of the cover plate necessary to the object to be heated.

Additionally, the cooktops described herein provide a grill plate identification system that automatically identifies a type of grill plate attached to the cooktop and applies predetermined operating limits to operation of the cooktop. The grill plate identification system increases user safety when operating the induction cooktop by automatically preventing operation of the cooktop beyond the limits for each type of grill plate. Moreover, additionally, the system prevents damage to components of the induction cooktop and/or the grill plate due to excessive heating.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. An induction cooktop comprising:
a housing defining a cavity;
an inner induction coil positioned within the cavity and having a first shape; and
an outer induction coil circumscribing said inner induction coil within the cavity and having a second shape different from the first shape of the inner induction coil.

2. The induction cooktop of claim 1, further comprising a control card configured to control power provided to said inner induction coil and said outer induction coil.

3. The induction cooktop of claim 1, wherein the inner induction coil is generally circular.

4. The induction cooktop of claim 1, wherein the outer induction coil is one of generally square, generally rectangular and generally ovate.

5. The induction cooktop of claim 1, wherein the inner conduction coil has a circumference, the outer induction coil being spaced from the inner induction coil about the circumference of the inner induction coil.

6. The induction cooktop of claim 1, wherein the outer induction coil is electrically coupled to the inner induction coil.

7. The induction cooktop of claim 6 wherein the outer induction coil is electrically connected in series to the inner induction coil.

8. A cooktop system comprising:
a housing;
a heating assembly disposed in the housing;
a first grill plate selectively releasably attachable to the housing over the heating assembly to define a cooking surface, the grill plate being of a first type of grill plate;
a second grill plate selectively releasably attachable to the housing over the heating assembly in place of the first grill plate, the second grill plate being of a second type of grill plate having at least one characteristic that distinguishes the second type of grill plate from the first type of grill plate;
a grill plate identification system on the housing, the first grill plate and the second grill plate to determine which of the first grill plate type and the second grill plate type is attached to the housing; and
a control card configured to apply predetermined operating limits to said heating assembly based on the grill type determination made by the grill plate identification system.

9. The cooktop system of claim 8, wherein the grill plate identification system comprises a capacitive touch input card positioned on the housing.

10. The cooktop system of claim 9, wherein the capacitive touch input card comprises a plurality of capacitive touch input sensors, the capacitive touch input card being configured to:
identify which of said plurality of capacitive touch input sensors detect an electrically capacitive circuit formed upon attachment of one of the first and second grill plates to the housing; and
transmit a signal identifying which of said plurality of capacitive touch input sensors made the detection.
